(19) United States
(12) Patent Application Publication
(10) Pub. No.: US 2002/0164443 A1
(43) Pub. Date: Nov. 7, 2002

(54) Geometyrical shaping of surfaces with a lotus effect

(75) Inventors: Markus Oles, Hattingen (DE); Edwin Nun, Billerbeck (DE); Bernhard Schleich, Recklinghausen (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CREAVIS Gesellschaft fuer Tech. und Innovation mbH, Marl (DE)

(21) Appl. No.: 10/090,772

(22) Filed: Mar. 6, 2002

(30) Foreign Application Priority Data
Mar. 6, 2001 (DE) 10110 589.4

(51) Int. Cl. B32B 3/00; B65D 1/00; B29D 22/00; F16L 1/00

(52) U.S. Cl. 428/35.7; 428/156

(57) ABSTRACT

A surface structure having protuberances with at least one protuberance configured as a three-dimensional rotationally symmetric shape. The surface structure can be included as surfaces on containers, pipettes, films, semifinished products, or reaction vessels.

### CROSS-REFERENCE TO RELATED APPLICATIONS

This application is related to German Patent Application No. 10110589.4, filed Mar. 6, 2001, the entire contents of which are incorporated herein by reference.

### BACKGROUND OF THE INVENTION

1. Field of the Invention

The present invention relates to a surface structure having a low surface energy.

2. Description of the Related Art

Surfaces with a combination of microstructure and low surface energy are known to exhibit interesting properties. A suitable combination of structure and hydrophobicity renders it possible that even slight amounts of moving water can entrain dirt particles adhering to the surface and clean the surface completely (e.g. see WO 96/04123 and U.S. Pat. No. 3,354,022, the entire contents of which are incorporated herein by reference). European Pat. No. 0 933 380, the entire contents of which are incorporated by reference, discloses that an aspect ratio of >1 and a surface energy of less than 20 mN/m are required for such surfaces. The aspect ratio is defined to be a quotient of a height of a structure to a width of the structure.

Water-repellent surfaces are described in the literature. Swiss Patent No. 268258, the entire contents of which are incorporated by reference, describes a method in which structured surfaces are produced by applying powders such as kaolin, talcum, clay or silica gel. Swiss Patent No. 268258 does not, however, disclose a particle size distribution or radii of curvature of the applied particles.

PCT/EP 00/02424, the entire contents of which are incorporated by reference, discloses that it is technically possible to render surfaces of objects artificially self-cleaning. The surface structures, composed of protuberances and depressions, required for the self-cleaning purpose have a spacing between the protuberances of the surface structures in the range of 0.1 to 200 μm and a height of the protuberances in the range from 0.1 to 100 μm. The materials used for this purpose must consist of hydrophobic polymers or a durably hydrophobized material. Detergents must be prevented from dissolving from the supporting matrix. As in the documents previously described, no information is given either on the geometrical shape or radii of curvature of the structures used.

Methods for producing these structured surfaces are likewise known. In addition to molding these structures in a fashion true to detail by way of a master structure using injection molding or by an embossing method, methods are also known which use the application of particles to a surface (e.g. see U.S. Pat. No. 5,599,489, the entire contents of which are incorporated by reference). However, it is common to all these methods that the self-cleaning behavior of these surfaces is described by a very high aspect ratio.

High aspect ratios (that is to say high, narrow objects) can be realized technically only with difficulty, and have low mechanical stability.

In the recently published work of G. Öner and T. J. McCarthy in Langmuir 2000, 16, 7777-7782, the entire contents of which are incorporated by reference, there was reported no connection between the aspect ratio and the advancing and receding contact angles. The contact angles were reported as independent of the height of the structures and independent of the surface chemistry. Further, the contact angles were disclosed as independent of the geometrical structures. However, the receding contact angle was reported to increase with an increasing structural spacing.

### SUMMARY OF THE INVENTION

One object of the present invention is to provide surfaces and more specifically a surface structure which exhibits a high contact angle with water or other fluids, i.e. to provide surfaces with what is termed a “lotus” effect, even without a high aspect ratio of the protuberance on the surface.

In the present invention, it has been surprisingly discovered that an aspect ratio greater than 1 is not decisive for the lotus effect. More important than the aspect ratio is a correct curvature of a side of the structure facing the water. This property of correct curvature is denoted in this application as a curvature response of the surface.

In the present invention, it has been discovered that structures, with protuberances which can be described by continuous functions which exhibit a rotational symmetry running through a maximum, respond in a substantially more hydrophobic fashion than protuberances which can be described by noncontinuous geometrical functions. Cylinders or columns having rectangular base surfaces are examples of noncontinuous geometrical shapes. There is always a mathematical discontinuity present in the transition from one face to another face such as, for example, from an end face of a rectangular column to a side face of a rectangular column. In the present invention, it has been discovered that substantially better lotus properties are achieved as soon as the transition from one face to another can be described continuously by a function. In this case, a sufficiently large radius is maintained in a transition from an end face to a side face. In continuation, the side faces drop away downward and, in the idiom of function theory, change their curvature response from a convex to a concave curvature response. The concave curvature profile then merges into a carrier matrix or into the next structural element. Thus, the present invention contradicts the above reported independence of contact angle on the geometrical structure of the surface.

Curves that have a shape of a choked off vesicle, or the curved shape of a water drop, show a particularly good effect. An undercut is present technically in this case.

### BRIEF DESCRIPTION OF THE DRAWINGS

A more complete appreciation of the present invention and many attendant advantages thereof will be readily obtained as the same becomes better understood by reference to the following detailed description when considered in connection with the accompanying drawings, wherein:

FIG. 1 is a graph of a parabolic function (a=−50; b=1 and c=300) exemplary of a two-dimensional section through a corresponding three-dimensional rotationally symmetric protuberance of a surface structure according to the present invention;

FIG. 2 is a graph of irrational functions (left-hand side, a=50, b=0, c=1000; right-hand side a=0.05, b=0, c=1000) exemplary of a two-dimensional section through a corresponding three-dimensional rotationally symmetric protuberance of a surface structure according to the invention;

FIG. 3 is a graph of an exponential function (a=1, b=0, c=0.09) exemplary of a two-dimensional section through a corresponding three-dimensional rotationally symmetric protuberance of a surface structure according to the invention;

FIG. 4 is a graph of a strophoid (a=5 and t[−2,2]) exemplary of a two-dimensional section through a corresponding three-dimensional rotationally symmetric protuberance of a surface structure according to the invention;

FIG. 5 is a graph of a Pascal's limacon (left-hand side, a=1, 1=0.6) exemplary of a two-dimensional section through a corresponding three-dimensional rotationally symmetric protuberance of a surface structure according to the invention;

FIG. 6 is a graph of a prolate cycloid (a=5 and λ=2, with preferred connection to a carrier plane at y=10) exemplary of a two-dimensional section through a corresponding three-dimensional rotationally symmetric protuberance of a surface structure according to the invention;

FIG. 7 is a schematic depicting (a) on the left-hand side, a surface according to the present invention in which a droplet on the surface has only a very few points of contact and low contact area between the drop and the surface, and (b) on the right-hand side, a structure in which the contact points and the contact area are higher.

### DETAILED DESCRIPTION OF THE PREFERRED EMBODIMENTS

Embodiments of the present invention are described in detail referring to the drawings, wherein like reference numerals designate identical or corresponding parts throughout the several views.

One aspect of the present invention includes a surface structure having protuberances with a mean height of 50 nm to 200 μm and a mean spacing of 50 nm to 200 μm, the external shapes of which are described by a mathematical function having rotational symmetry with reference to a maximum.

The protuberances of the surface structure, according to the invention, can in particular be described by functions such as for example an exponential function, an irrational function, a parabolic function, or a trigonometric function.

The protuberances of the surface structure, according to the invention, can also be described by mathematical curves, in particular by at elast one of a Cartesian folium, a strophoid, Pascal's limacon, a cardioid, Cassinian curve, a prolate cycloid and epicycloid, or a combination of these.

It is, additionally, possible for the function, according to the invention, to have at least two zeros in the second derivative (f″(x)), and for the function to be ≠0 at these points. Here, the zeros have the formal criteria for a change in the curvature response of the function; that is to say f″(a)=0 and f″(x) has a change in sign at the point a.

Alternatively, the functions, according to the invention, can have no zeros in the second derivative, so that the functions exhibit a convex shape.

According to the invention, the curved shapes must run through a centroid axis in a rotationally symmetrical fashion. For the sake of simplicity, the curved shapes will be described below by a two-dimensional section through a corresponding three-dimensional rotationally symmetrical protuberance, using the parametric or functional representation shown below:

Parabolic Function:

The form given below:

f(x)=ax²+bx+c (1)

has an axis of rotation: f(x)=−x/2a and the maximum

$$( \frac{- b}{2 a} , \frac{4 a c - {b}^{2}}{4 a} ) \qquad ( 2 )$$

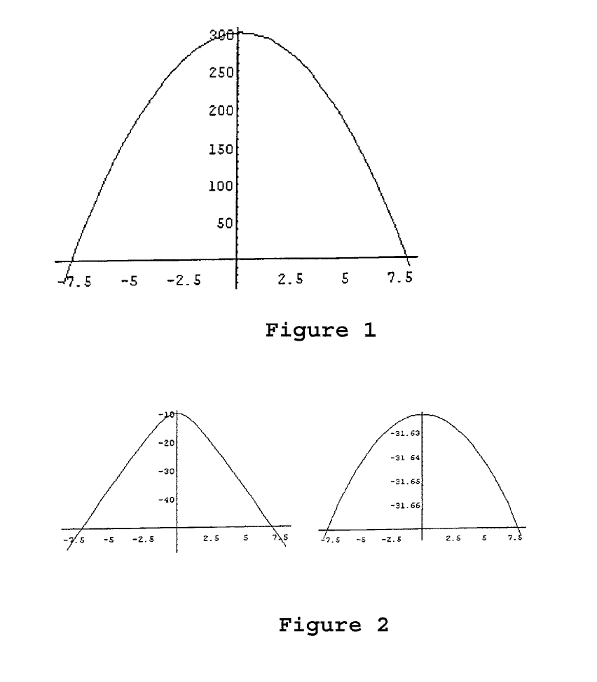

FIG. 1 shows, by way of example, a section of a parabolic function which can serve as a description for protuberances of a surface structure according to the present invention.

For Irrational Functions:

The form given below:

f(x)=±\sqrt{ax²+bx+c} (3)

This equation describes an ellipse for a <0, and a hyperbola for a >0. The extrema are:

$$( \frac{- b}{2 a} , \pm \sqrt{\frac{δ}{4 a}} ) \qquad ( 4 )$$

where δ=4ac−b².

FIG. 2 shows, by way of example, sections of irrational functions which can serve as a description for protuberances of a surface structure according to the invention.

For Exponential Functions:

The form given below:

f(x)=ae^{bx+cx}^{²} (5)

This exponential function is symmetrical about a vertical axis of symmetry x=−b/2c, the x-axis (the base surface in the present invention) is not cut. Since this is a mathematical requirement, in practice, the function will cut the base surface.

This function has an interesting technical property for c >0. Although it has no points of inflection, that is to say it is always convex, protuberances of its surface, which follow this function, exhibit outstanding lotus properties. The function falls from −≡ down to the minimum and then rises again up to +≡.

This function goes over into a Gaussian curve in the case c<0. The function rises from x=−∞ up to the maximum, and then drops again down to x=+∞. The maximum is at

$$( \frac{- b}{2 a c} , {ae}^{- {b}^{2} / 4 c} ) ,$$

the points of inflection are at

$$( \frac{- b \pm \sqrt{- 2 c}}{2 c} , {ae}^{\frac{- ( {b}^{2} + 2 c )}{4 c}} ) . \qquad ( 6 )$$

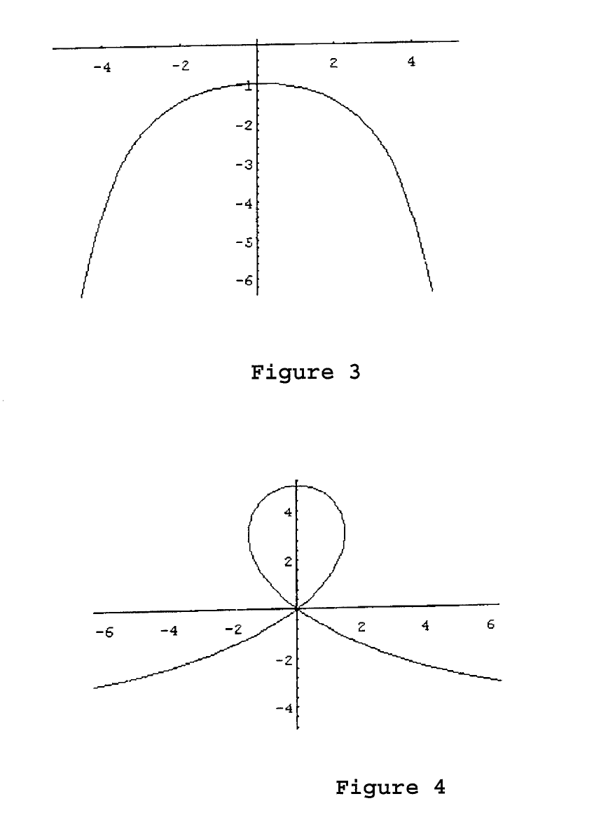

FIG. 3 shows, by way of example, a section of an exponential function which can serve as a description for protuberances of a surface structure according to the invention.

Trigonometric Functions:

Sinusoidal or cosinusoidal functions, for example can be utilized.

Cartesian Folium:

The form given below:

x³+y³−3axy=0

respectively

y=3at²/1+t³, and

x=3at/1+t³,

where −∞<t<−1 and −1<t<∞.

Strophoid:

The form given below:

(x+a)x²+(x−a)y²=0

respectively

x=−at(t²−1)/(t²+1),

y=a(t²−1)/(t²+1), and

a>0 and −∞<t<∞.

FIG. 4 shows a section of a strophoid which can serve as a description for protuberances of a surface structure according to the invention.

Pascal's Limacon:

The form given below:

(x²+y²−ax)²−l(x²+y²)=0

respectively

y=a·cos²t+l·cos t,

x=a·cos t·sin t+l·sin t, and

a>0, 1>0and 0≦t<2π.

Curves with the parameters a <1<2a and a >1 are particularly suitable.

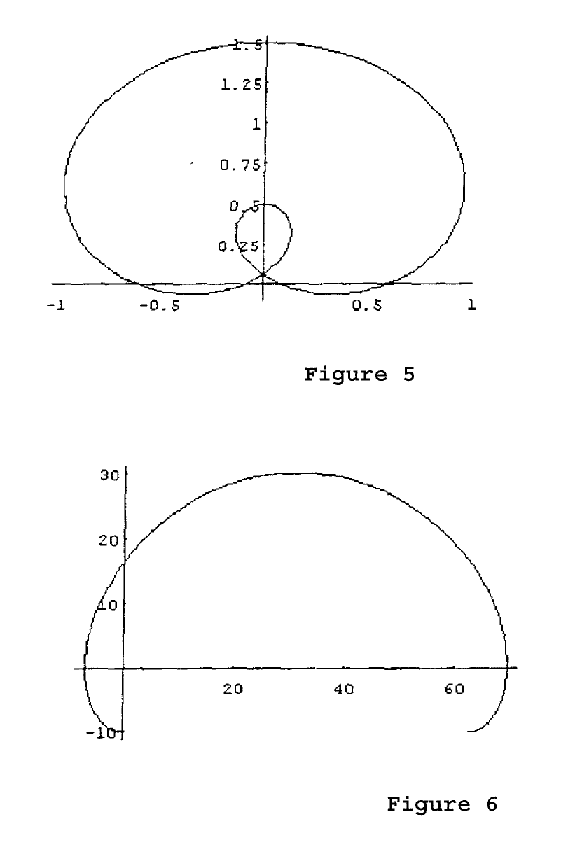

FIG. 5 shows a section of a Pascal's limacon which can serve as a description for protuberances of a surface structure according to the invention.

Cardioid:

The form given below:

(x²+y²)(x²+y²−2ax)−a²y²=0

respectively

x=a·cos t·(1+cos t), and

y=a·sin t·(1+cos t),

where a>0 and 0≦t<2π.

Represented in polar coordinates by the form given below:

ρ=a(1+cos φ)

Cassinian Curve:

The form given below:

(x²+y²)²−2c²(x²−y²)−(a⁴+c⁴)=0,

and

c>0, a>0.

Curves for which it holds that: c<a<c\sqrt{2} are particularly suitable.

Prolate Cycloid:

The form given below:

x=a(t−λ·sin t),

and

y=a(t−λ·cos t),

where λ>1.

FIG. 6 shows a section of a prolate cycloid which can serve as a description for protuberances of a surface structure according to the invention.

Epicycloids:

The form given below:

x=a(2·cos φλ·cos(2φ)),

and

y=a(2·sin φ−λ·sin(2φ)),

where: a>0, −∞<φ<∞.

FIGS. 1 to 6 show, by way of example, protuberances according to the invention and their mathematical curves or functions.

The surface of intersection of these functions or curves with the base line can occur at arbitrary points and corresponds in reality to a base surface of a carrier matrix or a carrier plane. For the surfaces shown in FIGS. 1-6, the surface of intersection of the curves with the base surface occurs at y=0 in the case of the strophoid and of the Pascal's limacon, and at y=−10 in the case of the prolate cycloid, and corresponds in reality to the base surface of the carrier matrix in the present invention.

The height of the protuberances can be defined via their spacing. These functions preferably have amplitude of at least 3/10 of the spacing between the protuberances.

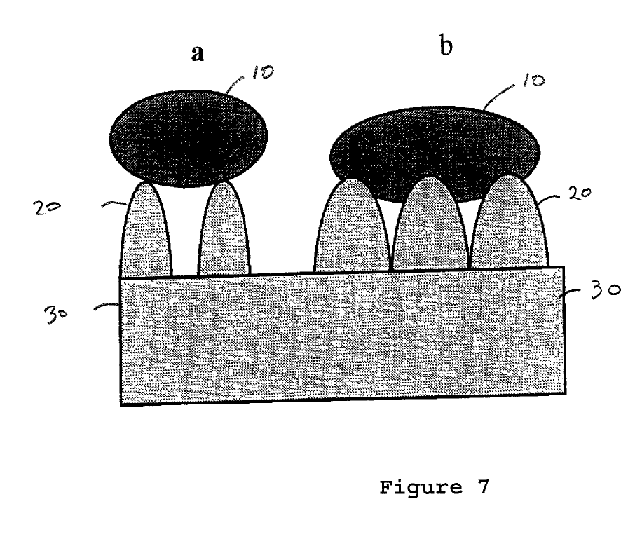

The protuberances of the surface structure of the invention preferably do not change their curvature response, that is to say the convex protuberances are present. It is possible that only the side of the protuberances that faces the water drop is convex. A water drop lying on a plurality of mutually adjacent protuberances then detaches itself quickly from the surface. Due to the force of surface tension of the water, the water drop tends to assume a spherical shape and therefore tries to find few points of contact with the surface. The above-described functions or types of curve are selected, according to the invention, such that the drop leaves the surface and is not drawn into the surface structures. This state in which a drop is not drawn into the surface structures is illustrated by way of example in FIG. 7. FIG. 7 shows on the left-hand side (a) a surface having separated structures (i.e. a lacuna) having a response, according to the invention, in which a drop 10 contact only at a few points of the protuberances 20, while the right-hand side (b) shows a surface having a structure in which there are large contact surfaces between the drop 10 and the protuberances 10 on the surface of the carrier 30, and the drop 10 is drawn deeply into the structure.

The geometrical shape of the protuberances is described in the ideal case by the above-noted mathematical functions, but molding is possible technically only with deviations from the ideal case.

The deviation of the protuberances of the surface structure, according to the invention, from the mathematical functions can be specified by a fit of the surfaces which, evaluated using a χ²-test, does not exceed a significant level of α<0.05.

Furthermore, it is possible that, according to the present invention, the contact surface of the protuberances with the carrier plane is smaller than the projection of a contour of the protuberances onto the carrier plane.

The production of the surface structure according to the invention can be performed as described in EP 0 933 380 or WO 96/04 123, the entire contents of both references are incorporated herein by reference.

Suitable materials, according to the present invention, are, for example:

Elements: gold, titanium, silicon, carbon;

Inorganic compounds: quartz glass, lithium niobate, silicon nitride, hydroxylapatite;

Polymers: PPMA, silicones, epoxy resins, polydioxanone, polyamide, poly-imide, collagen, fibronectin, fibrin.

Materials within the meaning of the present invention are products which already have their final form for use, semifinished products, or intermediates such as, for example, films which still have to go through a shaping process, such as for example melting, casting or extruding. Surface structures, according to the present invention, can have high contact angles.

Another aspect of the present invention includes the use of the surface structure to produce products which cannot be wetted by polar or nonpolar liquids, or can be wetted by them only with difficulty. Since the surface structure according to the present invention have particularly high contact angles, the present invention prevents the wetting of the surface and leads to a quick formation of drops. Given an appropriate inclination of the surface, the drops roll off the protuberances, pick up dirt particles in the process, and thereby simultaneously clean the surface.

The surface structure, according to the present invention, is not only hydrophobic, but also oleophobic. This property widens the fields of application of the surface structures of the present invention to include areas where it is necessary to deal with oil-containing liquids or contaminants such as, for example, road traffic, rail traffic and air traffic, as well as in industrial manufacturing plants.

Articles having the surface structure according to the present invention are very easy to clean. If droplets rolling down, such as for example rainwater, dew or other water, occurring in the area of application of the article are insufficient for cleaning, the articles having surfaces structure according to the present invention can be cleaned by rinsing with water.

In order to adhere to a surface or to multiply on a surface, bacteria and other microorganisms require water, which is not available on the hydrophobic surfaces of the present invention. Thus, the surface structure according to the invention prevent the growth of bacteria and other microorganisms, and are therefore bacteriophobic and/or antimicrobial.

Characterization of surfaces with reference to their wettability can be performed by measuring the surface energy. This variable is accessible, for example, by measuring the contact angles between smooth materials and various liquids (e.g. see Owens et al., J. Appl. Polym. Sci. 13, 1741 (1969), the entire contents of which are incorporated herein by reference). The surface energy is specified in mN/M (millinewtons per meter). As determined by Owens et al., smooth polytetrafluoroethylene surfaces have a surface energy of 19.1 mN/m, the contact angle the smooth polytetrafluoroethylene surface and water being 110°. In general, hydrophobic materials have contact angles with water greater than 90°.

The determination of the contact angle or the surface energy is expediently performed on smooth surfaces in order to better compare results. The material property of “hydrophobicity” is determined by the chemical composition of the uppermost molecular layer of the surface. A higher contact angle or lower surface energy of a material can therefore also be achieved by coating methods.

A macroscopically observed contact angle is therefore a surface property that reflects the material property plus the surface structure.

A particularly low surface energy is particularly necessary when, not only hydrophobic, but also oleophobic behavior is required. This is the case, in particular, with non-solid and oily contaminants. Specifically, these contaminants can lead in the case of non-oleophobic surfaces to wetting with oil, and this effect has a lasting negative influences on the properties. In each case, the surface energy of the smooth, non-structured surfaces is to be below 20 mN/m, preferably 10 to 20 mN/m.

In addition to the structural properties of the material, the chemical properties are important in achieving low contact angles according to the present invention. The chemical composition of the uppermost monolayer of the material influences the contact angle.

The surface structure according to the present invention can therefore be produced from materials which already exhibit hydrophobic behavior before being structured. These materials contain, in particular, bulk polymers with polytetrafluoroethylene, polyvinylidenefluoride or polymers made from perfluoroalkoxy compounds, whether as homopolymers or copolymers or as a mixing constituent of a polymer blend.

Also viable, according to the present invention, are mixtures of polymers with additives which align themselves during the shaping process such that hydrophobic groups predominate at the surface. Fluorinated waxes, for example Hostaflons from Hoechst AG, can be included as an additive.

The structuring of the surface structure, according to the present invention, can be carried out after application of a hydrophobic coating material.

Chemical modifications, according to the present invention, can also be carried out after the shaping, such that the protuberances can be subsequently filled with a material having a surface energy of 10 to 20 mN/m.

Since, in particular, the chemical properties of the uppermost monolayer of the material influence the contact angle, a surface modification with compounds which contain hydrophobic groups may be advantageous. Methods, according to the present invention, include covalent bonding of monomers or oligomers to the surface by way of a chemical reaction, such as for example treatments with alkylfluorosilanes such as Dynasilan F 8261 from Sivento Chemie Rheinfelden GmbH, or with fluorinated ormocers.

Also included in the present invention are methods in which radical sites produced on the surfaces react in the presence or absence of oxygen with radically polymerizable monomers. The activation of the surfaces can be performed by means of plasma, UV radiation or gamma radiation, as well as specific photoinitiators. The monomers can be grafted on after the activation of the surface, that is to say generation of free radicals. Such a method, according to the present invention, generates a coating which is particularly resistive in mechanical terms.

The coating of a material or of a surface structure of the present invention by way of plasma polymerization of fluoroalkenes or fully fluorinated or partly fluorinated vinyl compounds has proved to be particularly effective. The hydrophobization of a surface structure by way of an HF hollow-cathode plasma source with argon as carrier gas and C₄F₈ as monomer at a pressure of about 0.2 mbar constitutes, according to the present invention, a technically simple and elegant variant for subsequent coating.

Moreover, an already fabricated object can be coated, according to the present invention, with a thin layer of a hydrophobic polymer. This coating can be in the form of a finish or by polymerization of appropriate monomers on the surface of the object. Solutions or dispersions of polymers such as, for example, polyvinylidene fluoride (PVDF), or reactive finishes can be used as the polymeric finish.

Suitable monomers of the present invention for polymerization of materials on the surface structure of the present invention include alkylfluorosilanes, such as Dynasilan F 8261 (Sivento Chemie Rheinfelden GmbH, Rheinfelden).

Shaping or structuring of the surface structure of the present invention can be performed, according to the present invention, by impression/rolling or simultaneously during macroscopic shaping of the article, such as for example casting, injection molding, or other shaping methods. Appropriate negative molds of the desired structure are required for this purpose.

Negative molds, according to the present invention, can be produced industrially, for example by way of the Liga technique (e.g. see R. Wechsung in Mikroelektronik, 9, (1995) page 34 ff., the entire contents of which are incorporated herein by reference). In the Liga technique, one or more masks are first produced by electron beam lithography according to the dimensions of the desired protuberance. These masks serve for exposure of a photoresist layer by deep X-ray lithography, with the result that a positive mold is obtained. The intermediate spaces in the photoresist are then filled by electrodeposition of a metal. The metal structure thus obtained is a negative mold for the desired structure.

The protuberances can have a periodic arrangement. However, stochastic distributions of the protuberances are also permissible.

Surface structures produced according to the present invention are transparent for structures smaller than 400 nm, and are therefore suitable for all applications in which high transmission or good optical properties are important.

In particular, the production or a coating for headlamps, windscreens, advertising surfaces or coverings of solar cells (photovoltaic and thermal) are included in the present invention.

A further field of use for the surface structures of the invention is in containers to be emptied without leaving a residue, or holders to be rapidly cleaned such as, for example, wafer holders in semiconductor production. Within the semiconductor production process, wafers are transported with special holders (i.e. cassettes) into various baths. To avoid transfer of the various bath liquids, cleaning steps, in particular for the holders, are required. The cleaning or drying steps can be dispensed with if the respective bath liquid drips off completely from the holder on removal of the wafer from the bath.

Surface structures of the invention are therefore extremely suitable for the manufacture of products whose surface promotes the elimination of liquids from that surface. Surface structures of the present invention are preferably used for manufacturing objects which are self-cleaning, or self-emptying, as a result of water running off. Preferred applications of the present invention include, but are not limited to, containers, transparent bodies, pipettes, reaction vessels, films, semi-finished products and holders.

The examples below describe the present invention in more detail, but in no way restrict the scope of the present invention.

### EXAMPLE 1

The surface structure described by the present invention can be produced, for example, by way of an injection molding method in combination with a conventional injection mold produced using for example the Liga method, as discussed above. The Liga method is a structuring method which is based on a process including X-ray lithography, electroplating, and casting. The method is distinguished from micromechanics in that the structures are not generated by an etching process in the basic material, but can be cast cos t-effectively via a mold. In the present example, the Liga method serves to produce a mold. The irrational function

f(x)=±¢\sqrt{ax²+bx+c}

is exposed with the parameters a=50, b=0, c=1000 in a variation-sensitive polymer. In this case, the protuberances are produced in accordance with the function illustrated on the left-hand side of FIG. 2. The irrational function is illustrated in the interval −7.5 to 7.5, and the scaling is 10⁻⁷ m, that is to say protuberances with a spacing of about 1.5 μm in width and a height of 1 μm are introduced into the polymer. This structure is exposed periodically into the polymer at the spacing of 1.5 μm. This exposure produces a periodic pattern of “peaks” which exhibit a period of 1.5 μm and a height of 1 μm. After the lithographic resist has been exposed into the radiation-sensitive polymer and after development, the finished structure thus produced is used as a mold for an electroplating process in which a metal alloy is deposited in the exposed interspaces.

Subsequently, the finished structure is removed, and the metal structure remaining is used as a molding tool (e.g., see G. Gerlach, W. Dötzel “Grundlagen der Mikrostystemtechnik” [Fundamentals of microsystem technology] by Carl Hanser Verlag Munich, 1997, page 60f, the entire contents of which are incorporated herein by reference).

According to the present invention, the surface structure was molded in poly(propylene) using this molding tool. The mold was subsequently exposed to UV radiation of 254 nm for two minutes. Fluoroalkyl acrylate was grafted thermally onto the surfaces thus activated. The surface energy of about 28 mN/m was reduced to less than 15 mN/m by this procedure.

The surface structure thus produced in Example 1 has an outstanding lotus effect.

### EXAMPLE 2

The surface structure described by the present invention can be produced, for example, by way of an injection molding method in combination with a conventional injection mold produced using the above-noted Liga method. In the present example, the Liga method serves to produce the mold. A function of the type of a “prolate cycloid” is exposed with the parameters a=5 and λ=2 into a radiation-sensitive polymer. Protuberances in accordance with the function illustrated in FIG. 6 are produced in this case. The curve is marked in the interval from 0 to 2λ, and the scaling is 10⁻⁷ m, that is to say protuberances with a spacing of about 3 μm in width and a height of 1 μm are introduced into the polymer. This structure is now exposed periodically into the polymer at the spacing of 3 μm. This exposure produces a periodic pattern of “hills” which exhibit a period of 3 μm and a height of 1 μm. After the lithographic resist has been exposed into the radiation-sensitive polymer and after development, the finished structure thus produced is used as a mold for an electroplating process in which a metal alloy is deposited in the exposed interspaces.

Subsequently, the finished structure is removed and the metal structure remaining is used as the above-noted a molding tool.

According to the present invention, the surface structure was molded in poly(propylene) using this tool. The mold was subsequently exposed to an UV radiation of 254 run for two minutes. Fluoroalkyl acrylate was grafted permanently onto the surfaces thus activated. The surface energy of about 28 mN/m was reduced to less than 15 mN/m by this procedure.

The surface structure thus produced in Example 2 has an outstanding lotus effect.

1. A surface structure comprising:
protuberances having a mean height of 50 nm to 200 μm and a mean spacing of 50 nm to 200 μm, at least one protuberance of said protuberances configured as a three-dimensional rotationally symmetric shape.

2. The surface structure according to claim 1, wherein the rotationally symmetric shape is defined by a two-dimensional section of a mathematical function including at least one of an exponential function, an irrational function, a parabolic function, and a trigonometric function.

3. The surface structure according to claim 2, wherein the mathematical function is defined by a mathematical curve.

4. The surface structure according to claim 3, wherein the mathematical curve is at least one of a Cartesian folium, a strophoid, Pascal's limacon, a cardioid, Cassinian curve, a prolate cycloid and epicycloid, and a combination of these curves.

5. The surface structure according to any one of claims 1 to 4, further comprising:
a carrier plane located at a base of said protuberances,
wherein a contact surface area of the at least one protuberance with the carrier plane is smaller than a projection area of a contour of the at least one protuberance onto the carrier plane.

6. The surface structure according to claim 5, wherein the protuberances have an amplitude above the carrier plane of at least 3/10 of a spacing between the protuberances.

7. The surface structure according to claim 6, wherein the surface structure is included in at least one of produce containers, pipettes, films, semifinished products, and reaction vessels.

8. The surface structure according to claim 5, wherein the rotationally symmetric shape is defined by a two-dimensional section of a mathematical function which has at least two zero points in a second derivative of the mathematical function, and the mathematical function is not equal to 0 at the second derivative zero points.

9. The surface structure according to claim 5, wherein the rotationally symmetric shape is defined by a two-dimensional section of a mathematical function which has no zero points in the second derivative.

10. The surface structure according to claim 5, wherein the surface structure is included in at least one of produce containers, pipettes, films, semifinished products, and reaction vessels.

11. The surface structure according to claim 1, wherein the protuberances have an amplitude above a carrier plane of at least 3/10 of a spacing between the protuberances.

12. The surface structure according to claim 11, wherein the rotationally symmetric shape is defined by a two-dimensional section of a mathematical function which has at least two zero points in a second derivative of the mathematical function, and the mathematical function is not equal to 0 at the second derivative zero points

13. The surface structure according to claim 11, wherein the rotationally symmetric shape is defined by a two-dimensional section of a mathematical function which has no zero points in the second derivative.

14. The surface structure according to claim 2, wherein the mathematical function has at least two zero points in a second derivative of the mathematical function, and the mathematical function is not equal to 0 at the second derivative zero points

15. The surface structure according to claim 2, wherein the mathematical function has no zero points in the second derivative.

16. The surface structure according to claim 11, wherein the surface structure is included in at least one of produce containers, pipettes, films, semifinished products, and reaction vessels.

17. The surface structure according to claim 12, wherein the surface structure is included in at least one of produce containers, pipettes, films, semifinished products, and reaction vessels.

18. The surface structure according to claim 13, wherein the surface structure is included in at least one of produce containers, pipettes, films, semifinished products, and reaction vessels.

19. The surface structure according to claim 14, wherein the surface in structure is included in at least one of produce containers, pipettes, films, semifinished products, and reaction vessels.

20. A self-cleaning surface structure comprising:
a base surface; and
protuberances located on said base surface, at least one protuberance configured as a three-dimensional rotationally symmetric shape and the at least one protuberance having no mathematical discontinuities on a curvature of the rotationally symmetric shape.

21. The surface of claim 20, wherein the protuberances are coated with a hydrophobic polymer.
